(19) United States
(12) Patent Application Publication
(10) Pub. No.: US 2021/0231159 A1
(43) Pub. Date: Jul. 29, 2021

(54) ONE-PIECE NUT CAP

(71) Applicant: Novaria Holdings, LLC, North Richland Hills, TX (US)

(72) Inventor: Jimmy Wayne Mahaffey, Ravenden, AR (US)

(73) Assignee: Novaria Holdings, LLC, North Richland Hills, TX (US)

(21) Appl. No.: 17/161,470

(22) Filed: Jan. 28, 2021

Related U.S. Application Data
(60) Provisional application No. 62/967,148, filed on Jan. 29, 2020.

(51) Int. Cl. F16B 37/14

(52) U.S. Cl. CPC F16B 37/14

(57) ABSTRACT

A fastening system is disclosed. The fastening system may have a cap including a primary member and a plurality of prongs. The primary member includes a wall member and a floor member defining a conic section with an open end. The plurality of prongs extend radially inward from the wall member and are configured to contact at least one surface of at least one of a nut, bolt, and/or a washer.

### CROSS-REFERENCE TO RELATED APPLICATION(S)

This application claims the benefit of and priority to co-pending U.S. Prov. Pat. App. No. 62/967,148, filed on Jan. 29, 2020, and entitled “ONE-PIECE NUT CAP,” the disclosure of which is hereby incorporated by reference in its entirety.

### FIELD

The present disclosure relates generally to fasteners, and more specifically, to a cap to cover a nut and/or bolt.

### BACKGROUND

Frequently fasteners are used to join articles together. One such fastener may be a nut tightened along a bolt. Frequently the nut and/or protruding end of the bolt may be exposed to harsh elements, for instance moisture, chemicals, salt, etc. Moreover, the nut and/or protruding end of the bolt may contact proximate articles, such as wires passing nearby. In various instances, the exposure to harsh elements may wear, corrode, and/or rust the nut and/or bolt, causing weakness and/or difficulty loosening and/or fastening. Furthermore, nut and/or protruding end of the bolt may be desired to be electrically insulated from proximate articles. Yet also, contact between the nut and/or protruding end of the bolt and proximate articles may cause proximate articles, such as wires, to fray due to contact.

### SUMMARY

A cap is provided. The cap may include a primary member and a plurality of prongs. The primary member may include a wall member and a floor member defining a conic section with an open end. The plurality of prongs may extend radially inward from the wall member and contact at least one surface of at least one of a nut and a washer.

In various embodiments, the plurality of prongs may be a first set and a second set. The first set may be disposed proximate to the open end on a first plane and the second set may be disposed between the first set and the floor member on a second plane, different than the first plane.

In various embodiments, the plurality of prongs of the first set may be spaced apart along a perimeter of the wall member and the prong of the second set may be spaced apart along the perimeter of the wall member and offset from the first set such that the plurality of prongs extend along an inner surface of the wall member without interfering with each other.

In various embodiments, the plurality of prongs may each include a prong stem and at least two fingers extending from the stem in a U-shape and configured to engage with the nut or the washer such that ridges of the nut or the washer are configured to be engaged between the at least two fingers of each of the plurality of prongs.

In various embodiments, each of the at least two fingers may have edges extending laterally.

In various embodiments, the first set may be configured to engage the washer such that the edges of the at least two fingers of the plurality of prongs in the first set extend a first length and the prong stems of the plurality of prongs extend radially from the wall member a first distance.

In various embodiments, the second set may be configured to engage the nut such that the edges of the at least two fingers of the plurality of prongs in the second set extend a second length less than the first length and the prong stems of the plurality of prongs extend radially from the wall member a second distance greater than the first distance.

In various embodiments, the plurality of prongs may include a magnet disposed on the edges configured to engage with the nut or the washer.

In various embodiments, the first plane may be parallel to and spaced apart from the second plane.

In various embodiments, the cap may include a contact edge having an edge of the wall member of the primary member positioned opposite the floor member and configured to contact an article being joined by a combination of a nut and a bolt, wherein the cap at least partially encloses the nut.

In various embodiments, the contact edge may include an edge channel. The edge channel may include an annular groove defined in a face of the contact edge and forming a channel.

In various embodiments, the cap may include a skirt disposed adjacent the open end of the primary member, wherein the primary member has a first diameter and the skirt has a second diameter larger than the first diameter. The cap may include an aperture defined through the skirt, such that the aperture faces outward from the skirt and opens into the skirt parallel to a longitudinal axis of the cap.

In various embodiments, the cap may include an aperture disposed on an upper surface of the skirt, such that the aperture faces open along an axis parallel to the longitudinal axis of the cap.

In another embodiment, a fastening system is provided. The fastening system may include a bolt, a nut fastened to the bolt, and a cap. The cap may include a primary member and a plurality of prongs. The primary member may include a wall member and a floor member defining a conic section with an open end. The plurality of prongs may extend radially inward from the wall member and contact at least one surface of at least one of the nut and the bolt. The cap may be configured to couple to at least one of the nut and the bolt such that a portion of the bolt and the nut are inside a cavity of the cap.

In various embodiments, the plurality of prongs may be a first set and a second set. The first set may be disposed proximate to the open end on a first plane and the second set may be disposed between the first set and the floor member on a second plane, different than the first plane.

In various embodiments, the plurality of prongs of the first set may be spaced apart along a perimeter of the wall member and the prong of the second set may be spaced apart along the perimeter of the wall member and offset from the first set such that the plurality of prongs extend along an inner surface of the wall member without interfering with each other.

In various embodiments, the plurality of prongs may each include a prong stem and at least two fingers extending from the stem in a U-shape and configured to engage with the nut or the bolt such that ridges of the nut or the bolt are configured to be engaged between the at least two fingers of each of the plurality of prongs.

In various embodiments, the first set may be configured to engage the nut such that the edges of the at least two fingers of the plurality of prongs in the first set extend a first length and the prong stems of the plurality of prongs extend radially from the wall member a first distance. The second set may be configured to engage the bolt such that the edges of the at least two fingers of the plurality of prongs in the second set extend a second length less than the first length and the prong stems of the plurality of prongs extend radially from the wall member a second distance greater than the first distance.

In various embodiments, the fastening system may include a contact edge including an edge of the wall member of the primary member positioned opposite the floor member and configured to contact an article being joined by a combination of the nut and the bolt. The cap may at least partially enclose the nut, wherein the contact edge comprises an edge channel. The edge channel may include an annular groove defined in a face of the contact edge and forming a channel. A skirt may be disposed adjacent the open end of the primary member, wherein the primary member has a first diameter and the skirt has a second diameter larger than the first diameter. An aperture may be defined through the skirt.

In another embodiment, a method of using a fastening system is provided. The method may include threading a nut onto a bolt, aligning a plurality of prongs disposed on an inner surface of a cap with at least one of the nut, the bolt, and a washer, and snapping the cap into place, wherein the plurality of prongs engages with the at least one of the nut, the bolt, and the washer.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates an isometric view of an example fastening system including a bolt, nut, washer, and cap, in accordance with various embodiments;

FIG. 2 illustrates a cut-away view of an example fastening system including a cap, in accordance with various embodiments;

FIG. 3 illustrates a side view of an example cap of an example fastening system, in accordance with various embodiments;

FIG. 4 illustrates a perspective view of an example cap, in accordance with various embodiments;

FIG. 5 illustrates a section view of an example cap including a plurality of prongs, in accordance with various embodiments;

FIG. 6 illustrates a detail view of a plurality of prongs of FIG. 5, in accordance with various embodiments;

FIG. 7 illustrates a section bottom view of an example cap including a plurality of prongs, in accordance with various embodiments;

FIG. 8 illustrates a perspective bottom view of an example cap including a plurality of prongs, in accordance with various embodiments;

FIG. 9 illustrates a section top view of an example fastening system including a plurality of prongs, in accordance with various embodiments;

FIG. 10 illustrates an isometric view of an example fastening system including a bolt, nut, washer, and cap, in accordance with various embodiments;

FIGS. 11-12 illustrate side views of an example cap of an example fastening system, in accordance with various embodiments;

FIG. 13 illustrates a top view of an example cap of an example fastening system, in accordance with various embodiments;

FIG. 14 illustrates a bottom view of an example cap including a plurality of prongs, in accordance with various embodiments;

FIG. 15 illustrates a perspective view of an example cap, in accordance with various embodiments

FIGS. 16A-16G illustrate example dimensions of a cap, in accordance with various embodiments; and

FIG. 17 illustrates an example method of using a fastening system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

To be oriented “outward” of an object means having a position farther from a shared reference point than the object. For example, to be outward of a longitudinal axis relative to an object means having a distance from the longitudinal axis, a lateral vector component of which is greater than that of a corresponding lateral vector component of the distance of the object from the shared longitudinal axis.

Similarly, as used herein a “direction” and an “opposing direction” comprise directions having a vector component extending at least partially in opposite directions, such as wherein the statement pointing in a “first direction” means having a vector component extending at least partially opposite an “opposing second direction.”

Finally, as used herein “forward” and “aft” may describe relative positions along a longitudinal axis relative to another object. As used herein, forward means toward to an extreme distal end of a threaded portion of the bolt, whereas aft means the opposite of forward. For example, a nut is typically forward of a washer when attached to a bolt, whereas a washer is typically aft of a nut when attached to a bolt.

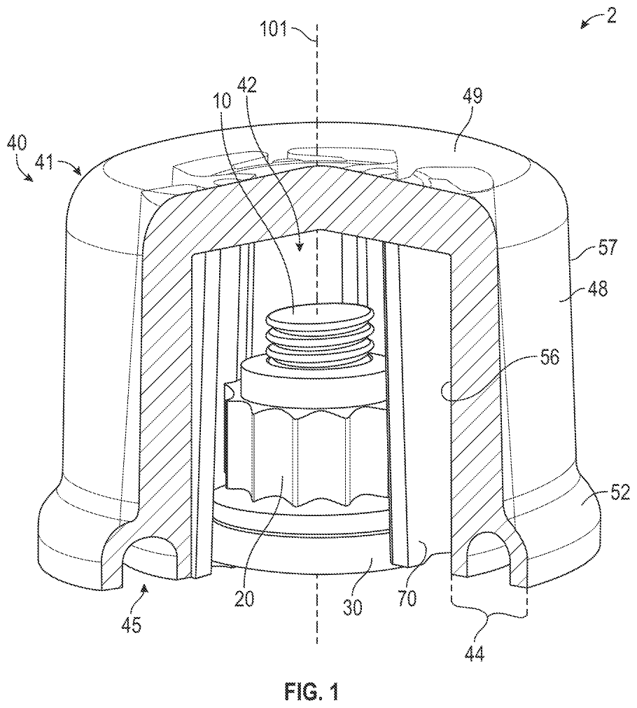

With reference to FIG. 1, a fastening system 2 is provided. The fastening system 2 comprises a combination of fastening elements configured to join at least two articles together. The fastening system 2 may include a bolt 10 and a nut 20 that can thread onto a threaded portion of the bolt 10, sandwiching articles to be joined along the length of the bolt 10. A shared central longitudinal axis 101 may align with a center of an aperture of the nut 20 and/or the central axis of the bolt 10, and/or a center of an aperture of a washer 30, and may extend longitudinally through the center of the bolt 10, nut 20, washer 30, and a cap 40, as will be described herein.

The fastening system 2 may include a washer 30. The washer 30 may be placed between the nut 20 and an article being loaded in compression by the combination of bolt 10 and nut 20. The washer 30 may increase the contact area of the nut 20 in conjunction with the article. For instance, the washer 30 may be an annular member compressible between the nut 20 and an object joined in compressive loading to the combination of nut 20 and bolt 10. The washer 30 includes a bolt channel (e.g., an aperture defined through a main washer body 31), such that the bolt channel is aligned centered on the central longitudinal axis 101 during use, the central longitudinal axis 101 extending normal to the main washer body 31 through a center of the bolt channel 32.

The fastening system 2 may also include a cap 40. The cap 40 may comprise a protective aspect. For instance, the cap 40 may define a cavity sized to receive at least a portion of a nut 20 and/or bolt 10 and may be joinable to the washer 30. For instance, the cap 40 may be closed on all but one size, and the one open side may be threadably connectable to the washer 30, wherein an internal cavity of the cap 40 is closed. In other embodiments, the one open side may be snapped into place using a plurality of prongs, as will be described herein. The washer 30 may be attachable to a cap 40 configured to enclose at least a portion of a nut 20 and/or bolt 10.

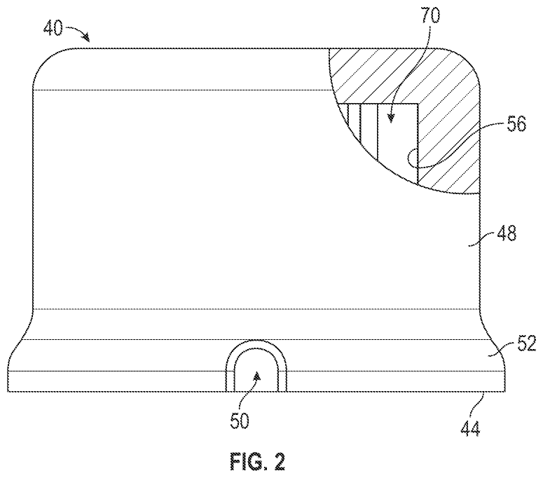

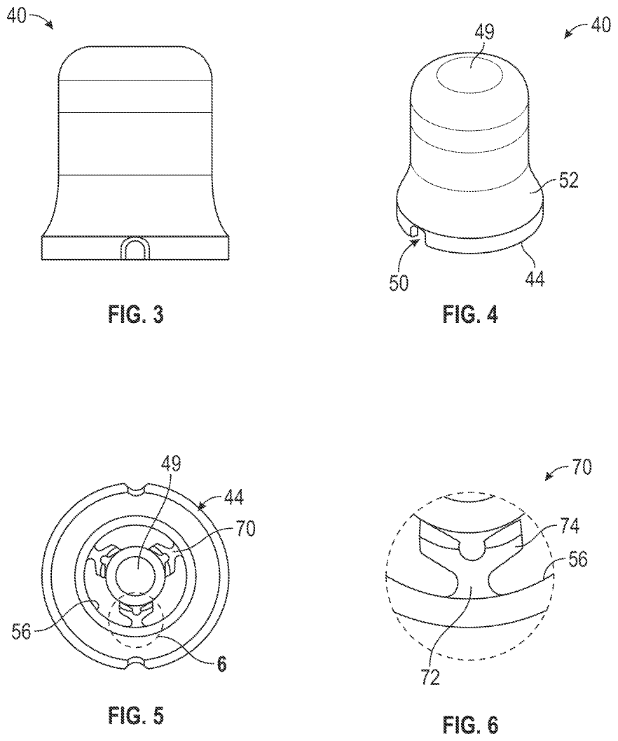

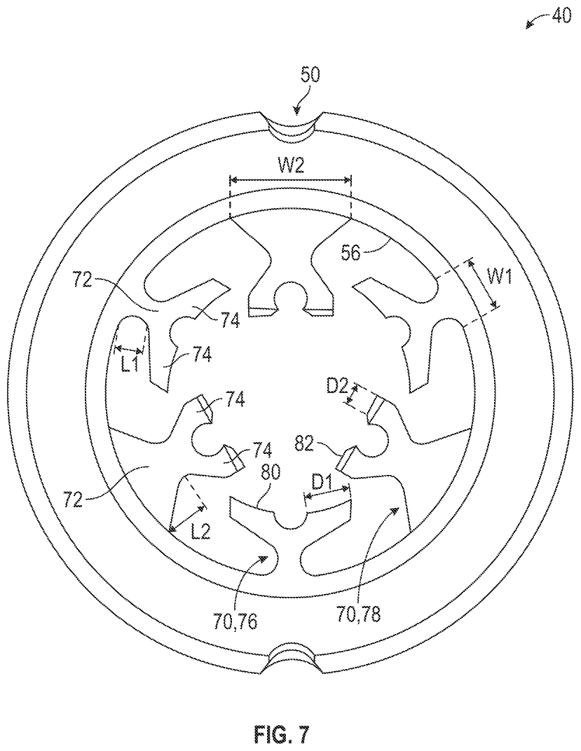

Shifting focus to the combination of FIGS. 1-6, the cap 40 is now discussed in further detail. The cap 40 comprises a covering member open on one face and otherwise closed to protect at least a portion of the washer 30, a nut 20, and a bolt 10. For instance, a cap 40 may be attached to one or more of the nut 20, the bolt 10, and/or the washer 30 so that a portion of the bolt 10 and a nut 20 are inside a cavity of the cap 40 and the washer 30 and/or an adjacent surface of an article being fastened by the bolt 10 and the nut 20 closes the cavity.

A cap 40 may comprise a primary member 41. A primary member 41 may comprise a main body of the cap 40. In various embodiments, a primary member 41 comprises a conic section with an open end. In various instances, the conic member presents cross-sections along the central longitudinal axis 101 comprising circles of varying radius. For instance, the conic member may present cross-sections along the central longitudinal axis 101 comprising circles of increasing radius nearer to the open end. In various embodiments, such a configuration presents a contrast to a constant radius cylinder of a cylindrical primary member, for instance. One may appreciate that by implementing conic structures, one may exploit an improved resiliency, strength, etc. associated with triangular structures (including triangle sections revolved about an axis, such as a conic section may represent) in contrast to trapezoidal structures (including trapezoid sections revolved about an axis, such as a cylinder section may represent). In further embodiments, a primary member 41 comprises any other shape as desired.

As shown herein, a primary member 41 may comprise a wall member 48 and a floor member 49. The wall member 48 and the floor member 49 may meet to form a closure on one end of the primary member 41. In this manner, a conical section with an open end may be formed. The cap 40 may thus define an inner cavity 42. An inner cavity 42 may comprise a space defined by the wall member 48 and the floor member 49 and configured to receive a portion of a bolt 10 and a nut 20 and to be enclosed at an open end by a washer 30 and/or an adjacent surface. Moreover, in various embodiments, the primary member 41 and the inner cavity 42 may be differently shaped structures. For instance, a primary member 41 may be an at least partially externally conic structure, whereas the inner cavity 42 may be at least partially cylindrical. Thus one may appreciate that the thickness of the wall member 48 may vary to accommodate differences in shape of the primary member 41 relative to an inner cavity 42 defined in the primary member 41.

The cap 40 may further include a skirt 52. A skirt 52 may comprise a local thickening of the cap 40 adjacent to the primary member 41. The skirt may comprise a local thickening of the primary member 41. The skirt may be formed of a same piece of material with the primary member 41 and may be continuous with the primary member 41. In various embodiments, the skirt may be adjacent to the primary member 41. The skirt may be attachable in physical communication with the primary member 41.

In various embodiments, a distance between an inward face (e.g., a face closer to the central longitudinal axis and disposed at least partially about the central longitudinal axis) and an outward face (e.g., a face farther from the central longitudinal axis and disposed at least partially about the central longitudinal axis) of the skirt may vary at stations along the central longitudinal axis. For instance, the distance between the inward face and the outward face may increase at stations approaching nearer to the edge channel 45 along the central longitudinal axis.

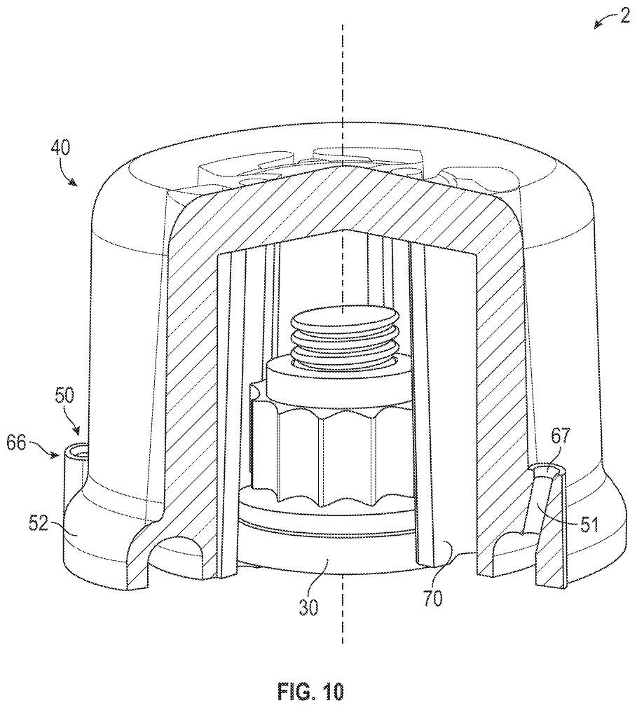

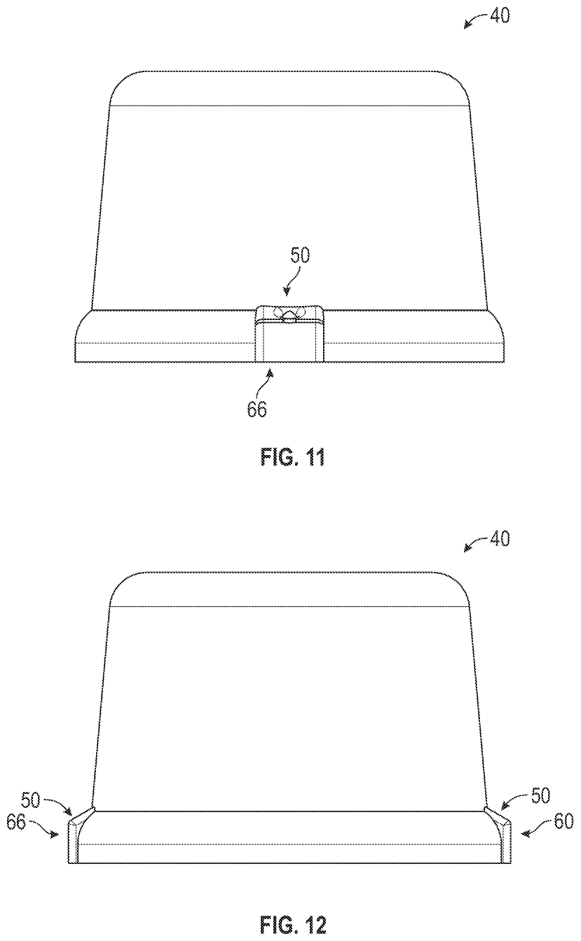

As contemplated above, the skirt 52 may be disposed on the open end of the primary member 41. More specifically, from a top view (e.g., a plane perpendicular to the central longitudinal axis 101), the floor member 49 may be circular. The wall member 48 may radially extend outward from the floor member 49, and from the floor member 49 to the skirt 52, such that a first end of the wall member 48 corresponding with the closed end of the primary member 41 has a smaller diameter than a diameter of a second end of the wall member which meets the skirt 52 at the open end of the primary member 41. The wall member 48 may correspond with cross-sections along the central longitudinal axis of the conic section comprising circles of increasing radius nearer and near to the open end. Thus, the wall member 48 may comprise a conic section joining the floor member 49 at an angle. The angle may be greater than 90 degrees, in contrast to that of a cylindrical cap 40 (see FIGS. 1, 2, 3 and 11, for example, for various cap profiles with varying degrees of increasing or otherwise varying cross-sections).

An outer diameter of the skirt 52 may similarly be larger than the diameter of the second end of the wall member 48 such that the skirt 52 extends radially outward from the wall member 48 but with differing radius at stations along the longitudinal axis, thus forming a shoulder to the primary member 41. In various instances, the skirt 52 presents cross-sections along the central longitudinal axis 101 comprising circles of varying radius. For instance, the skirt 52 may present cross-sections along the central longitudinal axis 101 comprising circles of increasing radius nearer and near to a contact edge 44. In various instances, the cross-sections may only increase for a first portion and transition to a constant radius for a second portion (e.g., along the height of an edge channel 45). As mentioned, the thickness of the skirt may also vary, so that a cross-section may have an annular shape, the annulus varying in thickness at different stations along the central longitudinal axis.

The wall member 48 may have an inner surface 56 and an outer surface 57. The outer surface 57 may appear conical from the floor member 49 to the skirt 52 (e.g., an inclined plane section). On the other hand, the inner surface 56 may straighten out (e.g., extend parallel to the central longitudinal axis 101 or cylindrically thereabout) for the distance of the skirt 52. The inner surface 56 may straighten out for the distance of the inner cavity 42. The inner surface 56 may straighten out for the distance of the inner surface 56. The inner surface 56 may straighten out for any distance as desired. For instance, the inner surface 56 and the outer surface 57 may present cross-sections along the central longitudinal axis 101 comprising circles of varying radius. For instance, the skirt 52 may present cross-sections along the central longitudinal axis 101 comprising circles of increasing radius nearer and near to the skirt 52. Along the length of the skirt 52, specifically the second portion, the radius of the inner surface 56 may cease increasing and be at least partially parallel to the central longitudinal axis 101. In various embodiments, the straightened inner surface may include a plurality of prongs.

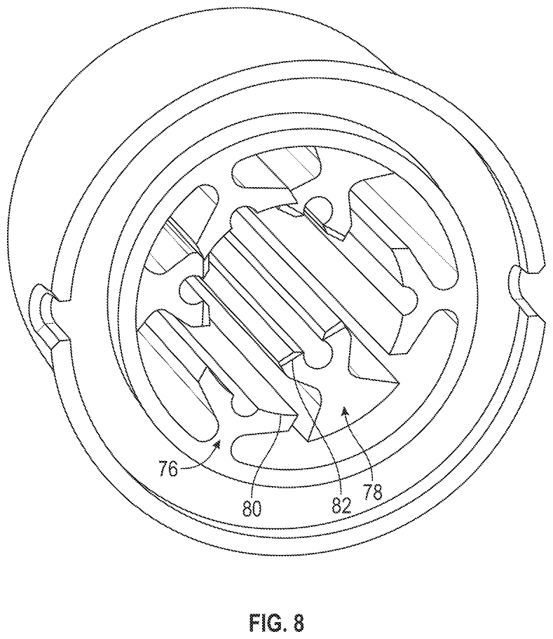

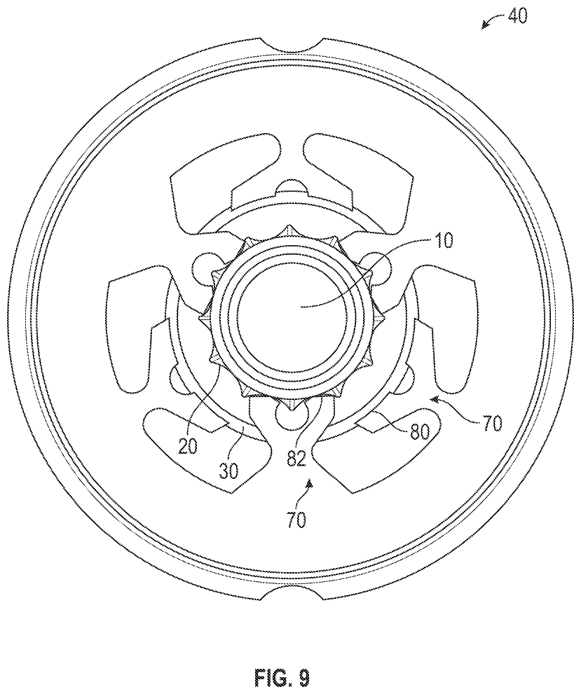

Referring now to FIGS. 5-9, the cap 40 includes a plurality of prongs 70. The plurality of prongs 70 are configured to receive at least a portion of at least one of the nut 20, the washer 30, and the bolt 10. The plurality of prongs 70 may be disposed along the inner surface 56 of the wall member 48, extending radially inward toward the center of the cap 40 (e.g., toward a central longitudinal axis 101) from the inner surface 46 of the wall member 48 and axially along the inner surface 46. The plurality of prongs 70 may be configured with a first set 76 and a second set 78. The first set 76 may be disposed proximate to the open end of the cap 40 (e.g., flush with the contact edge 44) extending along a first lateral plane. The second set 78 may be disposed between the first set 76 and inset from the contact edge 44, such that the second set 78 starts at a second lateral plane, different than the first lateral plane, the second lateral plane between the first lateral plane and the floor member. The first and second lateral planes may be radially extending planes (e.g., planes on a circular cross section of the cap 40). The plurality of prongs 70 of the first set 76 are spaced apart along a perimeter, or circumference, of the wall member (i.e., the inner surface 56). The plurality of prongs 70 of the second set 79 are spaced apart along a perimeter, or circumference, of the wall member (i.e., the inner surface 56) and offset from the first set such that the plurality of prongs 70 extend from the inner surface 56 without interfering with the first set 76. For instance, as shown from the bottom view in FIG. 7, the plurality of prongs 70 of the first set 76 may include three prongs 70 evenly spaced and the plurality of prongs 70 of the second set 78 may include three prongs 70 evenly spaced, each prong of the second set 78 positioned between prongs of the first set 76.

One or more of the plurality of prongs 70 may include a prong stem 72 having a first end in confronting relation with the inner surface 56 and a second end opposite the first end. In various embodiments the first end is formed unitarily with the inner surface 56 from a single piece of material. The prong stem 72 extends radially such that the prong stem 72 is generally perpendicular to the central longitudinal axis 101. The prong stems 72 of the plurality of prongs 70 of the first set 76 have a first radial length L1. The prong stems 72 of the plurality of prongs 70 of the second set 78 have a second radial length L2. In various embodiments, L2 may be greater than the first radial length L1. In further embodiments, L2 may be the same or about the same as L1. Moreover, in various embodiments, the first set 76 may be omitted. In further embodiments, the second set 78 may be omitted. In various embodiments, the first and second set are extant and L2 is greater than L1. For instance, the second set 78 is configured to contact the nut 20 which has a narrower diameter than the washer 30, whereas the first set 76 is configured to contact the washer 30. In various embodiments, the second set 78 is configured to contact the bolt 10 which has a narrower diameter than the nut 20 and/or washer 30, whereas the first set 76 is configured to contact the nut 20 and/or washer 30. Further, the prong stems 72 of the plurality of prongs 70 of the first set 76 may have a first base width W1, the base width being the contact surface between the prong stem 72 and the inner surface 56. The prong stems 72 of the plurality of prongs 70 of the second set 78 may have a second base width W2. In various embodiments, W2 is less than the first base width W1. In further embodiments W2 and W1 are the same or about the same.

The prong stem 72 may include one or more fingers 74 disposed at the second end. In various instances, the prong stem 72 includes a plurality of fingers 74 disposed at the second end. The plurality of fingers 74 may include two fingers 74 each extending opposite each other from the second end of the prong stem 72. For instance, the plurality of fingers 74 may form a U-shape, the open end of the “U” facing radially inwardly relative to the cap 40. For instance, the plurality of fingers 74 may form a U-shape, the open end of the “U” facing toward a central longitudinal axis 101, such may pass through a center of the cap 40. Thus, it may also be stated that the plurality of fingers 74 at least partially extend toward the center of the cap 40. In further instances, the plurality of fingers 74 may form a V-shape, or any other shape as desired, and may extend generally inwardly of the inner surface 56, or otherwise as described with respect to the U-shaped configuration.

The one or more fingers 74 of the one or more prongs 70 of first set 76 have edge(s) 80 at an end of the one or more fingers 74. The one or more fingers 74 of the one or more prongs 70 of second set 78 have edge(s) 82 at an end of the one or more fingers 74. The edges 80, 82 each extend laterally along their respective finger 74. As used herein laterally may mean generally in an arcuate circumferential direction relative to the center of a cap 40 and/or a central longitudinal axis. As used herein, laterally may mean generally perpendicularly to radial direction relative to the center of the cap 40 and/or a central longitudinal axis. Moreover, as used herein, laterally may mean generally perpendicularly to a corresponding stem. As used herein, the general perpendicularity in various embodiments may contemplate an at least partially linear edge. As used herein, the general perpendicularity in various embodiments may contemplate an at least partially arcuate edge.

The edges 80 extend a first distance D1 and the edges 82 extend a second distance D2. In various embodiments, D2 is less than the first distance D1. In further embodiments, D2 is not less than the first distance D1. In yet further embodiments, D2 is the same as D1. Because, in various embodiments, D2 is less than D1, also in various embodiments, the edges 80 having a greater surface area configured to engage with the nut 20 and/or washer 30 and the edges 82 have narrower edges 82 configured to engage with the bolt 10 and/or nut 20. For instance, when the edges 80 are engages with the washer 30, the edges 82 are engaged with the nut 20. In various embodiments, when the edges 80 are engaged with the nut 20, the edges 82 are engaged with the bolt 10. For instance, the ridges of the nut 20 may be engaged between the plurality of fingers 74 (e.g., received within the “U”). The edges 82 may further comprise a magnet configured to assist with securing the bolt 10 or nut 20 or washer 30 or an adjacent surface to the cap 40.

A cap 40 may include a contact edge 44. A contact edge 44 may comprise an edge of the primary member 41, specifically, an edge of the wall member 48 opposite the floor member 49 and an edge of the skirt 52, and configured to contact an article being joined by the bolt 10, nut 20, and washer 30. For instance, as the cap 40 snaps onto the nut 20, washer 30, and/or bolt 10, the contact edge 44 may contact an article being joined by the bolt 10, nut 20, and washer 30 and may exert an interference fit, pressing against the article. In various embodiments, the contact edge 44 comprises an edge of the primary member 41 lying in a normal plane of the central longitudinal axis 101, and comprising an edge of the skirt 52. Stated differently, the contact edge 44 comprises an annular face of the skirt 52 configured to contact an article being joined by the bolt 10, nut 20, and washer 30.

As described herein, the skirt 52 forms a shoulder to the primary member 41. The area within the skirt 52 changes at stations along the central longitudinal axis 101, from the wall member 48 to the bottom of the cap 40 (e.g., the contact edge 44). In some instances, the area within the skirt 52 increases (e.g., the skirt widens or thickens). As such, beneficially, the skirt 52 may be configured to widen and/or thicken to house an edge channel 45. In various embodiments, the contact edge 44 comprises the edge channel 45. An edge channel 45 may comprise an annular groove defined in a face of the contact edge 44, forming a channel within the skirt 52. The skirt 52 includes an inner surface that may be considered relatively straight, even with the inner surface 56, thus allowing the plurality of prongs 70 to extend smoothly along the inner surface 56 from the floor member 49 to the contact edge 44. The skirt 52 includes an outer surface which arches around the edge channel 45 providing adequate structural material both radially inward and radially outward of the edge channel 45. As described herein, the skirt 52 presents cross-sections along the central longitudinal axis 101 comprising circles of varying radius. As such, the outer surface of the skirt 52 may present cross-sections along the central longitudinal axis 101 comprising circles of increasing radius nearer to a contact edge 44. Again, in various instances, the cross-sections may only increase for a first portion and transition to a constant radius for a second portion (e.g., along the height of an edge channel 45). The inner surface of the skirt 52 may have a constant radius throughout its height extending along the central longitudinal axis 101. Thus, the outer surface of the skirt 52 may similarly straighten to be parallel to the portion of the inner surface of the skirt 52 forming the edge channel 45. In various embodiments, a radius of cross-sections of the inner surface of the skirt 52 may increase toward the contact edge 44 at a constant slope. In various embodiments, a radius of cross-sections of a first portion of the inner surface of the skirt 52 farther from the contact edge 44 may increase toward the contact edge 44 at a constant slope and a radius of cross-sections of a second portion of the inner surface of the skirt 52 nearer to the contact edge 44 may increase toward the contact edge 44 at a different constant slope. In yet further embodiments, a radius of cross-sections of a first portion of the inner surface of the skirt 52 farther from the contact edge 44 may increase toward the contact edge 44 at a constant slope and a radius of cross-sections of a second portion of the inner surface of the skirt 52 nearer to the contact edge 44 may be constant, not increasing toward the contact edge 44.

In various embodiments, the edge channel 45 facilitates flexure of the contact edge 44, facilitating compressive loading to ameliorate unscrewing of the cap 40. In further instances, the edge channel 45 is configured to receive a compressible O-ring, for example, to effectuate a fluid seal of the inner cavity 42 and ameliorate fluid ingress and subsequent corrosion and/or rust of the bolt 10, nut 20, and/or washer 30. In further instances, the edge channel 45 is configured to receive an injectable sealant, for instance, to be injected into the edge channel 45 after installation of the cap 40 over the bolt 10, nut 20, and/or washer 30, such as to effectuate a fluid seal of the inner cavity 42 and ameliorate fluid ingress and subsequent corrosion and/or rust of the bolt 10, nut 20, and/or washer 30, or fluid leakage through associated openings. The injectable sealant may be injected into the edge channel 45 via an aperture 50. The aperture 50 is disposed along an outer surface of the skirt 52. In various embodiments, the aperture 50 may open upwardly in a direction generally parallel to the central longitudinal axis 101. In various embodiments, the aperture 50 may open radially in a direction generally perpendicular to the central longitudinal axis 101 and/or generally parallel to a radius line extending perpendicularly from the central longitudinal axis 101. In further instances, the aperture 50 opens partially upwardly in an angled direction angled between the central longitudinal axis 101 and parallel to a radius line extending perpendicularly from the central longitudinal axis. In various instances, the aperture 50 opens partially upwardly in an angled direction angled 30 degrees or 45 degrees or 60 degrees or any selected angle relative to the central longitudinal axis 101.

Thus, a primary member has a wall member and a floor member defining a conic section with an open end. A skirt is disposed along the open end of the primary member, and a radially inward face of the wall member is configured to support the plurality of prongs 70 and receive at least one of a washer 30, nut 20, and/or bolt 10.

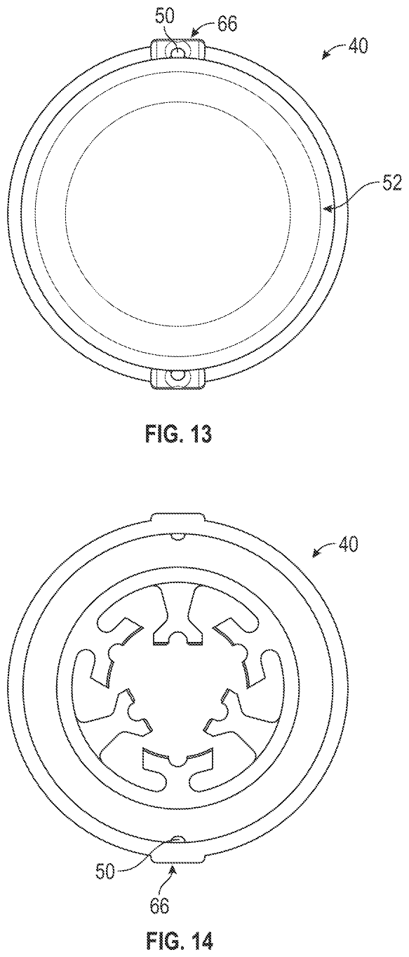

As shown in FIGS. 10-15, an aperture 50 may be disposed on an upper surface of the skirt 52 such that the aperture 50 extends radially outward and faces open along the central longitudinal axis 101. For instance, the aperture 50 may be disposed on a fill port stub 66. The aperture 50 is defined into the fill port stub 66 and is in fluid connection with a through channel 51. The through channel 51 is configured to connect the aperture 50 to the edge channel 45 such that the through channel 51 extends between the aperture 55 and the edge channel 45, and is in fluid connection with the edge channel 45. For instance, a sealant may be inserted in at the aperture 50 and fill the edge channel 45 via the through channel 51. Thus, the aperture 50 may be accessible by a user positioned above the cap 40. Depending on how and when a sealant may be inserted (e.g., pumped) into the edge channel 45, the aperture 50 as shown in FIG. 13A may create a difficult angle for a user to access, such as requiring access along a path generally radial to the longitudinal axis. The aperture 50 as shown in FIGS. 13B and 13C allows the user to use a tool orientation to insert the sealant that is similar to the orientation of the tool to tighten the fastening system and generally along a same axis. For example, a fastener driver could be inserted along an axis generally parallel to the longitudinal axis and similarly, and a sealant dispensing device could be inserted along a similar axis. As such, the fill port stub 66 may include a conic shelf 67 configured to selectably interface with a filling tool.

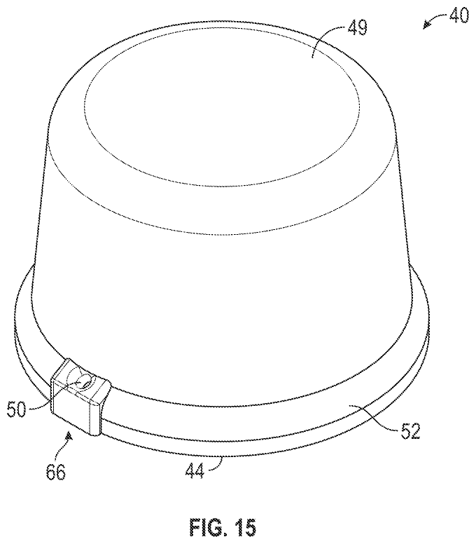

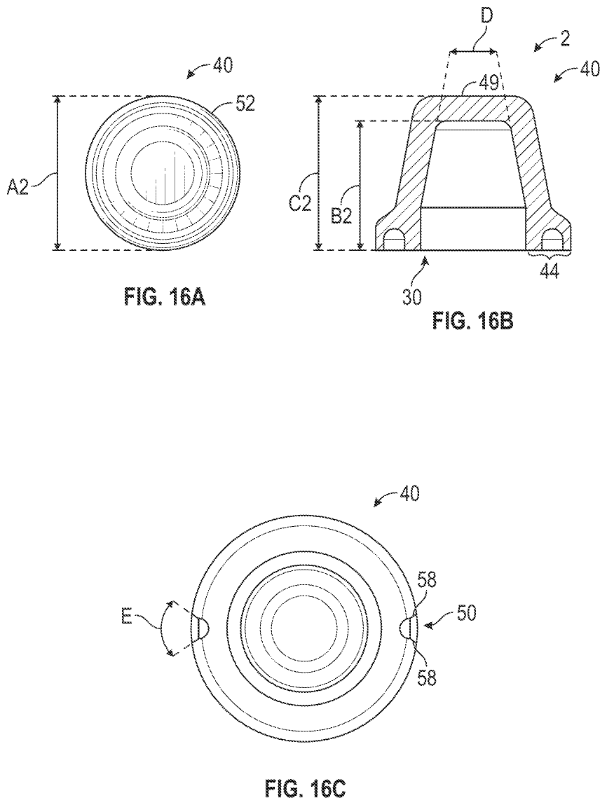

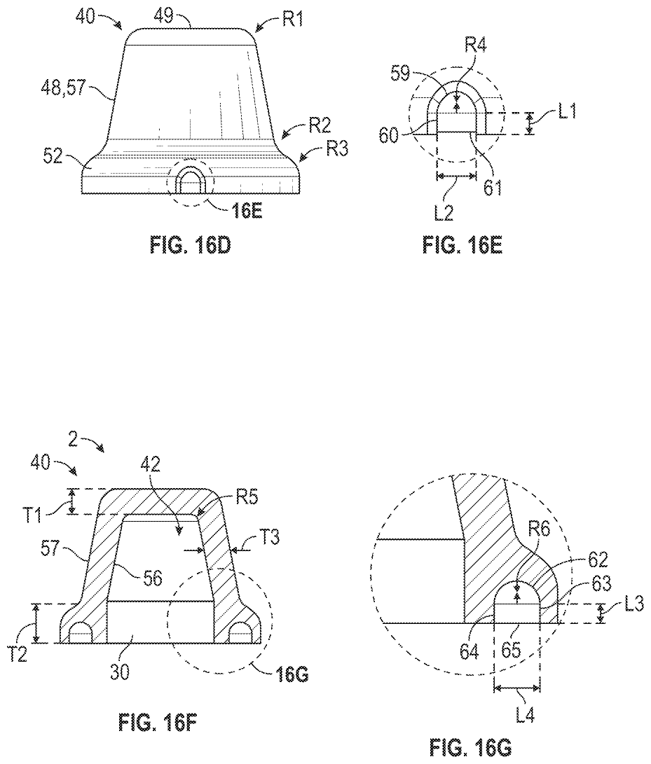

As shown in FIGS. 16A-16C, various non-limiting example dimensions are provided. For instance, the largest part of the skirt 52 has a diameter A2, the cap 40 from its open end to the top of the inner cavity has a height B2 (e.g., from the contact edge 44 to an inner surface of the floor member 49), the cap 40 has a height C2 (e.g., from the contact edge 44 to an outer surface of the floor member 49), the inner cavity 42 has a diameter D (e.g., inner surface of the floor member), and the aperture 50 has an angle E. Angle E defines the angle made by the side surfaces 58 of the aperture 50. As inclusive examples, which one of ordinary skill in the art would understand to be non-limiting, A may range from 0.980-.1.340 (e.g., 0.994+/−0.005 or 1.330+/−0.005), B may range from 0.020-0.645 (e.g., 0.639+/−0.005 or 0.025+/−0.005). C may range from 0.755-1.1 (e.g., 0.764+/−0.005 or 1.05+/−0.005). D may range from 0.36-0.67 (e.g., 0.365+/−0.003, 0.665+/−0.005). All dimensions described herein are in inches. E may range from 50-120 degrees (e.g., 66, 89.4, or 114.7 degrees). For further examples, see Chart 1 below.

CHART 1

| A | B | C | D |
|---|---|---|---|
| MAX | MIN | MAX | MIN |
| .941 | .468 | .603 | .287 |
| .999 | .634 | .769 | .362 |
| 1.134 | .694 | .829 | .432 |
| 1.279 | .789 | .924 | .507 |
| 1.335 | .920 | 1.055 | 1.047 |

Referring now to FIGS. 16D-16G, various non-limiting example dimensions are provided. In various embodiments, dimensions of the cap 40 are illustrated. As shown in FIG. 16D, R1 is a radius of a curved edge along the outer edge of the floor member 49 (e.g, a concave surface connecting the outer surface of the floor member 49 to the outer surface 57 of the wall member 48), R2 is a radius of a curved edge along the wall member 48 where the wall member 48 meets the skirt 52 (e.g., a convex surface connecting the outer surface of the floor member 49 to the outer surface of the skirt 52), and R3 is a radius of a curved edge along the skirt 52 (e.g., a concave surface rounding out the shoulder of the skirt 52 where the cross-sections cease increasing on the first portion and transition to a constant radius for the second portion of the skirt 52). As shown in FIG. 16E, Detail A of FIG. 16D, R4 is a radius of a top arch 59 of the aperture 50 and L1 is the height of a side surface 60 of the aperture 50. Thus, the total height of the aperture 50 is L1+R4. Further, L2 is the width of the aperture 50 along a floor surface 61 defined by the distance between the side surfaces 60.

As shown in FIG. 16F, R5 is the radius of a curved edge along the inner surface of the floor member 49 (e.g., a convex surface connecting the inner surface of the floor member to the inner surface 56 of the wall member 48 within the inner cavity 42). Further, T1 is the thickness of the top portion of the cap 40 (e.g., the distance between the outer surface and the inner surface of the floor member 49), T2 is the thickness of the portion of the inner surface 56 that may straighten out for the distance of the skirt 52, and T3 is the thickness of the wall member 48 (e.g., the distance from the inner surface 56 to the outer surface 57). As shown in FIG. 16G, Detail B of FIG. 16F, R6 is the radius of a top arch 62 of the edge channel 45 and L3 is the height of a side surface 63, 64 of the edge channel 45. Thus, the total height of the edge channel 45 is L3+R6. Further, L4 is the width of the edge channel 45 along a floor surface 65 defined by the distance between the side surfaces 63, 64. The top arch 62 and the side surfaces 63, 64 are bound by the internal structure of the skirt 52. T4 is the thickness of a portion of the skirt 52 forming the exterior portion of the edge channel 45 (e.g., the distance from the outer side surface 63 of the edge channel 45 to the outer surface of the skirt 52).

As inclusive examples, which one of ordinary skill in the art would understand to be non-limiting, R1 may be 100+/−0.005, R2 may be 0.045+/−0.005, R3 may be 0.05+/−0.003 or +/−0.005, and R4 may be 0.055+/−0.003. As inclusive examples, which one of ordinary skill in the art would understand to be non-limiting, L1 may be 0.05+/−0.005 or +/−0.006, L2 may be 0.09+/−0.005, L3 may be 0.050+/−0.005, and L4 may be 0.113+/−0.005. As inclusive examples, which one of ordinary skill in the art would understand to be non-limiting T1 may be 0.125+/−0.005, T2 may be 0.210 or 0.305, T3 may be 0.125+/0.005, and T4 may range from 0.042-0.05. All dimensions described herein are in inches. Although FIGS. 16A-16G are depicted with a smooth inner surface, the dimensions may be applied to the cap embodiments as described herein, including the plurality of prongs, which have been omitted in FIGS. 16A-16G for clarity.

To further illustrate this configuration, the fastening system 2, may be used inside a fuel tank of an aircraft, such as a section of a fuel tank inside a wing. The fastening system 2 is configured to seal the fuel from exiting the tank. Thus the fastening system 2 ameliorates leakage and/or fluidic communication between content of the fuel tank (or other environment) and adjacent structures. In this manner, the fastening system ameliorates exposure of surrounding components to content of the fuel tank, which may be undesirable or deleterious. The novel pronged cap assembly with provides safe and clean environmental protection for the aircraft.

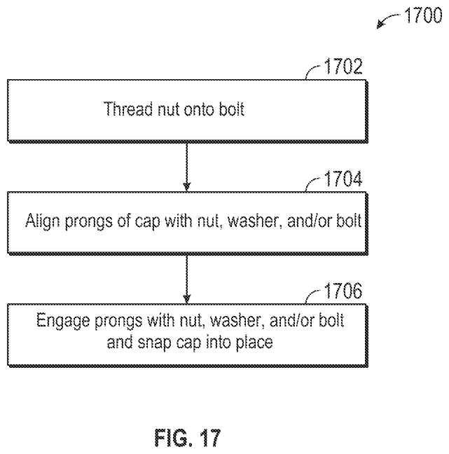

With reference to FIGS. 1-16G but with particular emphasis on FIG. 17, a method 1700 of using a fastening system 2 is provided. In various embodiments, a nut 20 may be threaded onto a bolt 10 (block 1702). The nut may be tightened against a washer 30 and/or an adjacent surface. A cap 40 may be aligned with the nut and/or the bolt. For instance, a plurality of prongs disposed on an inner surface of a cap may be aligned with at least one of the nut and the bolt (block 1704). In various embodiments include a washer 30, the plurality of prongs disposed on the inner surface of the cap may be aligned with at least one of the nut, the bolt, and the washer. The cap 40 may be snapped into place, wherein the plurality of prongs engages with the at least one of the nut 20 and/or the bolt 10 (block 1706). In various embodiments including the washer 30, the plurality of prongs engages with at least one of the nut, the bolt, and the washer to snap the cap 40 into place. In this manner, the cap 40 may be affixed over at least one of the nut 20 and the bolt 10 and may ameliorate environmental exposure thereof.

With reference to FIGS. 1-17, having discussed aspects of a fastening system 2, a fastening system 2, and/or its component washer 30 and/or cap 40 may be made of various materials. For instance, a fastening system 2, and/or its component washer 30 and/or cap 40 may be made of a single material, or different materials, or combinations of materials. For example, components of the system are made from metal. For example, aspects of a fastening system 2, and/or its component washer 30 and/or cap 40 are metal, such as nickel, cobalt, molybdenum, titanium, aluminum, steel, or stainless steel, though it alternatively comprises numerous other materials configured to provide support. Components of the system are optionally made from other materials such as, for example, composite, ceramic, plastics, polymers, alloys, glass, binder, epoxy, polyester, acrylic, or any material or combination of materials having desired material properties, such as heat tolerance, strength, stiffness, or weight. In various instances the cap 40 is transparent.

Portions of a fastening system 2, and/or its component washer 30 and/or cap 40 as disclosed herein are optionally made of different materials or combinations of materials, and/or comprise coatings. Moreover, components of the fastening system 2, and/or its component washer 30 and/or cap 40 are in some instances mixtures of different materials according to different ratios, gradients, and the like.

A fastening system 2, and/or its component washer 30 and/or cap 40 thus may have multiple materials, or any material configuration suitable to enhance or reinforce the resiliency and/or support of the system when subjected to wear in an operating environment such as an aircraft operating environment, or to satisfy other desired electromagnetic, chemical, physical, or material properties, for example coefficient of thermal expansion, ductility, weight, flexibility, strength, or heat tolerance.

One such material is Trogamid. In various embodiments, a fastening system 2, and/or its component washer 30 and/or cap 40 may comprise Trogamid, such as Trogamid CX7323 polyamide. In various embodiments, a fastening system 2, and/or its component washer 30 and/or cap 40 may comprise cadmium plate. The fastening system 2, and/or its component washer 30 and/or cap 40 may be passivated.

Further such material may be an austenitic nickel-chromium-based alloy such as Inconel®, which is available from Special Metals Corporation of New Hartford, N.Y., USA. Other such material includes ceramic matrix composite (CMC). Further material includes refractory metal, for example, an alloy of titanium, such as, titanium-zirconium-molybdenum (TZM).

Various benefits and advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A cap comprising:
a primary member comprising a wall member and a floor member defining a conic section with an open end; and
a plurality of prongs extending radially inward from the wall member and configured to contact at least one surface of at least one of a nut and a washer.

2. The cap of claim 1, wherein the plurality of prongs are configured in a first set and a second set, the first set disposed proximate to the open end on a first plane and the second set disposed between the first set and the floor member on a second plane, different than the first plane.

3. The cap of claim 2, wherein the plurality of prongs of the first set are spaced apart along a perimeter of the wall member and the prong of the second set are spaced apart along the perimeter of the wall member and offset from the first set such that the plurality of prongs extend along an inner surface of the wall member without interfering with each other.

4. The cap of claim 1, wherein the plurality of prongs each include a prong stem and at least two fingers extending from the stem in a U-shape and configured to engage with the nut or the washer such that ridges of the nut or the washer are configured to be engaged between the at least two fingers of each of the plurality of prongs.

5. The cap of claim 4, wherein each of the at least two fingers have edges extending laterally.

6. The cap of claim 5, wherein the first set is configured to engage the washer such that the edges of the at least two fingers of the plurality of prongs in the first set extend a first length and the prong stems of the plurality of prongs extend radially from the wall member a first distance.

7. The cap of claim 6, wherein the second set is configured to engage the nut such that the edges of the at least two fingers of the plurality of prongs in the second set extend a second length less than the first length and the prong stems of the plurality of prongs extend radially from the wall member a second distance greater than the first distance.

8. The cap of claim 5, wherein the plurality of prongs further comprise a magnet disposed on the edges configured to engage with the nut or the washer.

9. The washer according to claim 2, wherein the first plane is parallel to and spaced apart from the second plane.

10. The cap according to claim 1, further comprising a contact edge comprising an edge of the wall member of the primary member positioned opposite the floor member and configured to contact an article being joined by a combination of a nut and a bolt, wherein the cap at least partially encloses the nut.

11. The cap according to claim 10, wherein the contact edge comprises an edge channel, the edge channel comprising an annular groove defined in a face of the contact edge and forming a channel.

12. The cap according to claim 1, further comprising:
a skirt disposed adjacent the open end of the primary member, wherein the primary member has a first diameter and the skirt has a second diameter larger than the first diameter; and
an aperture defined through the skirt, such that the aperture faces outward from the skirt and opens into the skirt parallel to a longitudinal axis of the cap.

13. The cap according to claim 12, further comprising an aperture disposed on an upper surface of the skirt, such that the aperture faces open along an axis parallel to the longitudinal axis of the cap.

14. A fastening system comprising:
a bolt;
a nut fastened to the bolt; and
a cap comprising:
a primary member comprising a wall member and a floor member defining a conic section with an open end;
a plurality of prongs extending radially inward from the wall member and configured to contact at least one surface of at least one of the nut and the bolt; and
wherein the cap is configured to couple to at least one of the nut and the bolt such that a portion of the bolt and the nut are inside a cavity of the cap.

15. The fastening system of claim 14, wherein the plurality of prongs are configured in a first set and a second set, the first set disposed proximate to the open end on a first plane and the second set disposed between the first set and the floor member on a second plane, different than the first plane.

16. The fastening system of claim 15, wherein the plurality of prongs of the first set are spaced apart along a perimeter of the wall member and the prong of the second set are spaced apart along the perimeter of the wall member and offset from the first set such that the plurality of prongs extend along an inner surface of the wall member without interfering with each other.

17. The fastening system of claim 14, wherein the plurality of prongs each include a prong stem and at least two fingers extending from the stem in a U-shape and configured to engage with the nut or the bolt such that ridges of the nut or the bolt are configured to be engaged between the at least two fingers of each of the plurality of prongs.

18. The fastening system of claim 17, wherein the first set is configured to engage the nut such that the edges of the at least two fingers of the plurality of prongs in the first set extend a first length and the prong stems of the plurality of prongs extend radially from the wall member a first distance; and
the second set is configured to engage the bolt such that the edges of the at least two fingers of the plurality of prongs in the second set extend a second length less than the first length and the prong stems of the plurality of prongs extend radially from the wall member a second distance greater than the first distance.

19. The fastening system of claim 14, further comprising:
a contact edge comprising an edge of the wall member of the primary member positioned opposite the floor member and configured to contact an article being joined by a combination of the nut and the bolt, wherein the cap at least partially encloses the nut, wherein the contact edge comprises an edge channel, the edge channel comprising an annular groove defined in a face of the contact edge and forming a channel;
a skirt disposed adjacent the open end of the primary member, wherein the primary member has a first diameter and the skirt has a second diameter larger than the first diameter; and
an aperture defined through the skirt.

20. A method of using a fastening system, the method comprising:
threading a nut onto a bolt;
aligning a plurality of prongs disposed on an inner surface of a cap with at least one of the nut, the bolt, and a washer;
snapping the cap into place, wherein the plurality of prongs engages with the at least one of the nut, the bolt, and the washer.
